(19) United States
(12) Patent Application Publication
(10) Pub. No.: US 2023/0191369 A1
(43) Pub. Date: Jun. 22, 2023

(54) COATED ARTICLES AND METHODS OF PREPARING THE SAME

(71) Applicants: Saudi Arabian Oil Company, Dhahran (SA); King Fahd University of Petroleum & Minerals, Dhahran (SA)

(72) Inventors: Elaf A. Ahmed, Dhahran (SA); Hasan Al Abdulgader, Dammam (SA); Abdullahi B. Olabintan, Dhahran (SA); Tawfik A. Saleh, Dhahran (SA)

(21) Appl. No.: 17/645,207

(22) Filed: Dec. 20, 2021

(51) Int. Cl. B01J 20/26; B01J 20/28; B01J 20/32; C02F 1/28; C02F 1/40

(52) U.S. Cl. CPC B01J 20/262; B01J 20/3242; B01J 20/28004; B01J 20/28045; C02F 1/40; C02F 1/288

(57) ABSTRACT

Provided herein are coated articles comprising a foam and a coating comprising silanized nanoclay, and methods of preparing the same.

### TECHNICAL FIELD

Provided herein are coated articles useful for the treatment of produced water and oilfield wastewater. Also provided herein are methods of preparing the coated articles as disclosed herein.

### BACKGROUND

Various conventional processes have been used for the oil/water separation including in situ burning of surface oil, mechanical cleanup, electrochemical methods, bioremediation. In addition, chemical dispersants, solidifiers, and absorbent materials have been employed to deal with the oil spills.

Produced water or oilfield wastewater is a by-product of oil and gas operations, and its production is increasing. Various absorbents, including active carbon, zeolites, and natural fibers, have been used to remove contaminants from produced water. Active carbon, carbon composites, and graphene-based sponges have also been used for similar purposes.

### SUMMARY

Provided herein are coated article comprising: a polyurethane foam and a coating comprising silanized nanoclay, wherein the coating is supported by the polyurethane foam, and the silanized nanoclay comprises a phyllosilicate mineral and an organosilicate, wherein the organosilicate comprises one or more C8-C30 alkyl chains.

Also provided are methods of preparing the coated article of claim 1, wherein the method comprises steps of: a) admixing a nanoclay, an organosilane, water, and a base to form a silanized nanoclay; and b) coating a polyurethane foam with the silanized nanoclay to form the coated article.

Also provided herein are methods of treating water comprising admixing the coated article of claim 1 and an oil-water mixture.

The compositions and methods can allow for relatively low-cost, relatively stable, and/or relatively effective approaches for treating produced water and/or oilfield wastewater, for example, to remove contaminants from such water. The compositions and method can provide relatively good separation efficiency, relatively good selectivity, relatively reduced toxicity, relatively high recyclability, relatively low energy demand, relatively low operational cost, relatively simple fabrication methods, and reduced introduction of secondary pollutants.

In an aspect, the disclosure provides a coated article. The coated article comprises a polyurethane foam and a coating comprising silanized nanoclay. The coating is supported by the polyurethane foam. The silanized nanoclay comprises a phyllosilicate mineral and an organosilicate, and the organosilicate comprises one or more C8-C30 alkyl chains. Embodiments can include one or more of the following. The silanized nanoclay further comprises orthosilicate. The organosilicate comprises one or more C10-C24 alkyl chains, such as at least one C18 alkyl chains. The phyllosilicate mineral comprises one or more of halloysite, kaolinite, pyrophyllite, talc, illite, montmorillonite, chlorite, vermiculite, sepiolite, and palygorskite, such as montmorillonite. The silanized nanoclay has an average particle size distribution in a range of about 60 nm to about 90 nm, such as in a range of about 65 nm to about 85 nm. The coated article has a separation efficiency of at least 90 wt% (e.g., at least 95%) in an oil-water mixture, wherein the coated article is provided in an amount of about 5 wt% based on the total weight of oil-water mixture. The oil in the oil-water mixture comprises one or more of hexane, decane, dodecane, diesil oil, carbon tetrachloride, vegetable oil, and ethanol. The coated article sustains an absorption capacity of about ±10% of the first absorption capacity in an oil-water mixture for at least 5 absorption-desorption cycles

In an aspect, the disclosure provides a method of making a coated article. The method includes mixing a nanoclay, an organosilane, water, and a base to form a silanized nanoclay, and coating a polyurethane foam with the silanized nanoclay to form the coated article. Embodiments can include one or more of the following. The organosilane is octadecyltrimethoxysilane. Mixing further comprises a tetraalkoxysilane and/or orthosilicic acid. The base and water have a pH in a range of about 8 to about 11. Addmixing comprises heating the admixture at a temperature in a range of about 55° C. to about 65° C.

In an aspect, the disclosure provides a method of treating water that comprises mixing the coated article and an oil-water mixture. The oil-water mixture can be produced water. The method can further comprise at least partially separating the oil from the water by adsorbing at least some of the oil onto the coated particle.

### BRIEF DESCRIPTION OF FIGURES

FIG. 1 is a drawing of the fabrication process for a coated article as disclosed herein, such as, alkoxysilane-modified montmorillonite clay mineral (AOS@MMT) polyurethane foam (AOS@MMT-PF).

FIG. 2 is a graph of the separation efficiency of coated articles as disclosed herein in various oil-water mixtures.

FIG. 3 is a graph of the absorption capacity of coated articles as disclosed herein in various oils and organic solvents.

FIG. 4 is a graph of the absorption capacity of coated articles as disclosed herein in various oils and organic solvents for 1 to 10 absorption-desorption cycles.

FIG. 5 is a drawing of the synthesis of AOS@MMT.

### DETAILED DESCRIPTION

Provided herein are coated articles comprising a foam and a coating, wherein the coating comprises silanized nanoclay and the coating is supported by the polyurethane foam. In embodiments, the silanized nanoclay comprises a phyllosilicate mineral and an organosilicate. In embodiments, the organosilicate comprises one or more C8-C30 alkyl chains.

Embodiments of the coated articles disclosed herein can advantageously have one or more of the following properties selected from the group of: (1) high separation efficiency of oil and/or organic solvents from water, e.g., at least 90%, at least 95%, or at least 98% separation efficiency; (2) excellent absorbent reusability, e.g., the coated articles of the disclosure herein sustain an absorption capacity of about ±10% of the first absorption capacity in an oil-water mixture for at least 5 absorption-desorption cycles or the coated articles of the disclosure herein sustain an absorption capacity of about ±10% of the first absorption capacity in an oil-water mixture for at least 10 absorption-desorption cycles; (3) swift absorption of oil and/or organic solvents from water, e.g., the coated articles as disclosed herein achieve absorption capacity of the oil and/or organic solvents in a range of about 10 seconds to about 15 minutes, or about 30 seconds to 10 minutes, or about 30 seconds to 5 minutes; and (4) superhydrophobicity, e.g., the coated articles are superhydrophobic.

The coated articles as disclosed herein can be prepared by admixing a nanoclay, an organosilane, water, and a base to form a silanized nanoclay; and, coating a polyurethane foam in a dispersion of the silanized nanoclay to form the coated article. In embodiments, the polyurethane foam is coated by dip-coating.

Embodiments of the method of preparing the coated articles as disclosed herein can advantageously have one or more of the group of: (1) relatively few (e.g., minimal) amount of synthetic steps, e.g., two synthetic steps; (2) relatively low-cost starting materials; and (3) relatively high atom economy.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

It is also to be understood that the terminology used herein is for the purpose of describing particular aspects only and is not intended to be limiting. As used in the specification and in the claims, the term “comprising” can include the aspect of “consisting of.” Unless defined otherwise, all technical and scientific terms used herein have the same meaning as commonly understood by one of ordinary skill in the art to which the disclosed compositions and methods belong. In this specification and in the claims which follow, reference will be made to a number of terms which shall be defined herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The use of the terms “a,” “an,” “the,” and similar referents in the context of the disclosure herein (especially in the context of the claims) are to be construed to cover both the singular and the plural, unless otherwise indicated. Recitation of ranges of values herein merely are intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended to better illustrate the disclosure herein and is not a limitation on the scope of the disclosure herein unless otherwise indicated. No language in the specification should be construed as indicating any non-claimed element as essential to the practice of the disclosure herein.

### Coated Articles

The disclosure provides coated articles comprising a polyurethane foam and a coating comprising silanized nanoclay, wherein the coating is supported by the polyurethane foam, and the silanized nanoclay comprises a phyllosilicate mineral and an organosilicate, wherein the organosilicate comprises one or more C8-C30 alkyl chains. In embodiments, the silanized nanoclay further comprises orthosilicate.

As used herein, the term “alkyl” refers to straight chained and branched saturated hydrocarbon groups. The term Cn means the alkyl group has “n” carbon atoms. For example, C8 alkyl refers to an alkyl group that has 8 carbon atoms. C8-C30 alkyl refers to an alkyl group having a number of carbon atoms encompassing the entire range (i.e., 8 to 30 carbon atoms), as well as all subgroups (e.g., 8-28, 8-24, 10-30, 10-20 carbon atoms). Non-limiting examples of alkyl groups include, octyl, nonyl, decyl, undecyl, dodecyl, tridecyl, tetradecyl, pentadecyl, hexadecyl, heptadecyl, octadecyl, nonadecyl, and icosyl. Unless otherwise indicated, an alkyl group can be an unsubstituted alkyl group or a substituted alkyl group. The alkyl group can be substituted with 1-10 substituents selected from the group of: halogens (e.g., F, C1, Br, or I), C1-C6 alkyl, and C3-C6 cycloalkyl.

As used herein, the term “cycloalkyl” refers to an aliphatic cyclic hydrocarbon group that is monocyclic or polycyclic (e.g., bridged, fused, or spiro). The term Cn means the cycloalkyl group has “n” carbon atoms. For example, C5 cycloalkyl refers to a cycloalkyl group that has 5 carbon atoms in the ring. C3-C6 cycloalkyl refers to cycloalkyl groups having a number of carbon atoms encompassing the entire range (i.e., 3 to 6 carbon atoms), as well as all subgroups (e.g., 3-5, 4-6, 5-6, 3, 4, 5, and 6 carbon atoms). Nonlimiting examples of cycloalkyl groups include cyclopropyl, cyclobutyl, cyclopentyl, and cyclohexyl.

As used herein, the term “organosilicate” refers to a moiety according to formula (I): Si(O)ₙ(R)ₘ (I), wherein n is 1, 2, or 3 and m is 1, 2, or 3, the sum of n and m is 4, and R is C8-C30 alkyl, wherein each O is single bonded to the Si atom and is single bonded to an additional Si atom.

In embodiments, R is C8-C30. In embodiments, R is C8-28 alkyl. In embodiments, R is C10-C30 alkyl. In embodiments, R is C12-C30 alkyl. In embodiments, R is C12-C24 alkyl. In embodiments, R is C12-C22 alkyl. In embodiments, R is C12-C20 alkyl. In embodiments, R is C14-C20 alkyl. In embodiments, R is C14-C22 alkyl. In embodiments, R is C16-C24 alkyl. In embodiments, R is C16-C20 alkyl. In embodiments, R is C17-C19 alkyl. In embodiments, R is selected from the group of: C10 alkyl, C12 alkyl, C14 alkyl, C16 alkyl, and C18 alkyl. In embodiments, R is C12 alkyl. In embodiments, R is C14 alkyl. In embodiments, R is C16 alkyl. In embodiments, R is C18 alkyl.

In embodiments, n is 1, 2, or 3. In embodiments, n is 2 or 3. In embodiments, n is 3. In embodiments, n is 2. In embodiments, n is 1.

In embodiments, m is 1, 2, or 3. In embodiments, m is 1 or 2. In embodiments, m is 1. In embodiments, m is 2.

In embodiments, n is 3, m is 1, and R is C12-C20 alkyl. In embodiments, n is 3, m is 1, and R is C16-C20 alkyl. In embodiments, n is 3, m is 1, and R is C18 alkyl.

In embodiments, the silanized nanoclay further comprises orthosilicate. As used herein, the term “orthosilicate” refers to a moiety according to formula (II): Si(O)₄ (II), wherein each O is single bonded to the Si atom and is single bonded to an additional Si atom.

In embodiments, the phyllosilicate mineral comprises one or more of halloysite, kaolinite, pyrophyllite, talc, illite, montmorillonite, chlorite, vermiculite, sepiolite, and palygorskite. In embodiments, the phyllosilicate mineral comprises montmorillonite. In embodiments, the phyllosilicate mineral is montmorillonite.

In embodiments, the silanized nanoclay has an average particle size distribution in a range of about 60 nm to 90 nm (e.g., about 65 nm to 85 nm, about 70 nm to 80 nm, about 76 nm). In general, the average particle size distribution of the silanized clay is greater than the average particle size distribution of the nanoclay prior to silane modification.

The polyurethane foam of the disclosure herein can include any polyurethane foam suitable to one of ordinary skill in the art.

In embodiments, the coated article has a separation efficiency of at least 80 wt% in an oil-water mixture, wherein the coated article is provided in an amount of about 5 wt% based on the total weight of oil-water mixture. In embodiments, the coated article has a separation efficiency of at least 90 wt% in an oil-water mixture, wherein the coated article is provided in an amount of about 5 wt% based on the total weight of oil-water mixture. In embodiments, the coated article has a separation efficiency of at least 95 wt% in an oil-water mixture, wherein the coated article is provided in an amount of about 5 wt% based on the total weight of oil-water mixture. In embodiments, the coated article has a separation efficiency of at least 98 wt% in an oil-water mixture, wherein the coated article is provided in an amount of about 5 wt% based on the total weight of oil-water mixture. In embodiments, the coated article has a separation efficiency of at least 99 wt% in an oil-water mixture, wherein the coated article is provided in an amount of about 5 wt% based on the total weight of oil-water mixture. In embodiments, the coated article absorbs oil from the oil-water mixture at room temperature. In embodiments, the separation efficiency is calculated using a coated article as disclosed herein provided in an amount of about 5 wt% based on the total weight of oil-water mixture.

The separation efficiency of a coated particle as disclosed herein can be calculated using equation I:

$$S e p a r a t i o n e f f i c i e n c y \left(\%\right) = \frac{{m}_{r}}{{m}_{0}} \times 100$$

wherein mᵣ is the weight of the absorbed oil by the coated article and m₀ is the initial weight of the oil in the oil-water mixture.

As used herein, the term “oil-water mixture” refers to a mixture of oil and water, wherein the oil comprises organic solvents and/or liquid derived from petroleum. In embodiments, the oil comprises one or more of hexane, decane, dodecane, diesel oil, carbon tetrachloride, vegetable oil, ethanol, and an oil mixture, wherein the oil mixture is a mixture of hexane, decane, dodecane, diesel oil, carbon tetrachloride, vegetable oil, and ethanol. In embodiments, the oil comprises one or more of hexane, decane, dodecane, carbon tetrachloride, and ethanol. In embodiments, the oil comprises one or more of diesel oil and vegetable oil.

In embodiments, the coated article sustains an absorption capacity of about ±10% of the first absorption capacity in an oil-water mixture for at least 5 absorption-desorption cycles. In embodiments, the coated article sustains an absorption capacity of about ±10% of the first absorption capacity in an oil-water mixture for at least 10 absorption-desorption cycles. In embodiments, the coated article sustains an absorption capacity of about ±8% of the first absorption capacity in an oil-water mixture for at least 5 absorption-desorption cycles. In embodiments, the coated article sustains an absorption capacity of about ±8% of the first absorption capacity in an oil-water mixture for at least 10 absorption-desorption cycles.

The absorption capacity of the coated articles as disclosed herein for various oils can be calculated using equation II:

$$A b s o r p t i o n c a p a c i t y = \frac{{m}_{c} - m}{m}$$

wherein m_{c} is the coated article weight after immersion in the oil/organic solvent, and m is the coated article weight prior to immersion in the oil/organic solvent.

The absorption capacity of a foam disclosed herein can be determined as follows. A selected oil sample was introduced dropwise into a beaker. Next, the initially weighed AOS@MMT-PF was dipped in the oil samples to be completely absorbed. When the saturated foam was taken out of the beaker, its weight was again measured and recorded. Lastly, the saturated sponge was repetitively squeezed to expel most of the absorbed oil. The mean value of each of the sample tested for at least three trials was recorded. The absorption capacity of the absorbent materials (Q) for different oils were calculated using the equation below:

$$A b s o r p t i o n c a p a c i t y = m c \text{-} m m$$

where mc is the foam weight after immersion in oil in grams, and m is the weight of the dry foam in grams.

The efficiency of separation of AOS@MMT-PF foam can be determined for different oils. A weighted AOS@MMT-KSF-PF sample was introduced into an oil-water mixture and allowed to absorb at ambient temperature. The efficiency of separation of the absorbent is calculated using the equation:

$$S e p a r a t i o n e f f i c i e n c y \% = m r m 0 \times 100$$

where mr was the weight of the retrieved oil (or organic solvent), and m0 was the original weight of the oil sample in the mixture. Moreover, the process was repeated to assess the reusability of the AOS@MMT-PF in the absorption test. A total of 10 absorption-desorption experiments were carried out.

### Methods of Preparing the Coated Article

Provided herein are methods of preparing the coated article as disclosed herein, wherein the method comprises steps of: a) admixing a nanoclay, an organosilane, water, and a base to form a silanized nanoclay; and b) coating a polyurethane foam with the silanized nanoclay to form the coated article as disclosed herein.

As used herein, the term “nanoclay” refers to nanoparticles comprising layered mineral silicates. In embodiments, the nanoclay comprises a phyllosilicate mineral. Non-limiting examples of nanoclays include halloysite, kaolinite, pyrophyllite, talc, illite, montmorillonite, chlorite, vermiculite, sepiolite, and palygorskite. In embodiments, the nanoclay is montmorillonite. Montmorillonite can be desirable because, for example, of its availability of phyllosilicate groups that allow further modification with hydrophobic branches such as octadecyl. However, as would be understood by one of skill in the art, other clays may be used.

In embodiments, the nanoclay has an average particle size distribution in a range of about 40 nm to 80 nm (e.g., from about 50 nm to 70 nm, from about 55 nm to 65 nm, about 60 nm).

As used herein, the term “organosilane” refers to a compound having a formula of: Si(OR¹)_{n′}(R²)_{m′}, wherein R¹ is C1-C6 alkyl, R² is C8-C30 alkyl, n′ is 1, 2, or 3, m′ is 1, 2, or 3, and the sum of n′ and m′ is 4.

In embodiments, R¹ is C1-C6 alkyl. In embodiments, R¹ is C1-C4 alkyl. In embodiments, R¹ is C1-C2 alkyl. In embodiments, R¹ is C1 alkyl. In embodiments, R¹ is C2 alkyl.

In embodiments, R² is C8-C30. In embodiments, R² is C8-28 alkyl. In embodiments, R² is C10-C30 alkyl. In embodiments, R² is C12-C30 alkyl. In embodiments, R² is C12-C24 alkyl. In embodiments, R² is C12-C22 alkyl. In embodiments, R² is C12-C20 alkyl. In embodiments, R² is C14-C20 alkyl. In embodiments, R² is C14-C22 alkyl. In embodiments, R² is C16-C24 alkyl. In embodiments, R² is C16-C20 alkyl. In embodiments, R² is C17-C19 alkyl. In embodiments, R² is selected from the group of: C10 alkyl, C12 alkyl, C14 alkyl, C16 alkyl, and C18 alkyl. In embodiments, R² is C12 alkyl. In embodiments, R² is C14 alkyl. In embodiments, R² is C16 alkyl. In embodiments, R² is C18 alkyl.

In embodiments, n′ is 1, 2, or 3. In embodiments, n′ is 2 or 3. In embodiments, n′ is 3. In embodiments, n′ is 2. In embodiments, n′ is 1.

In embodiments, m′ is 1, 2, or 3. In embodiments, m′ is 1 or 2. In embodiments, m′ is 1. In embodiments, m′ is 2.

In embodiments, n′ is 3, m′ is 1, R¹ is C1 alkyl, and R² is C12-C20 alkyl. In embodiments, n′ is 3, m′ is 1, R¹ is C2 alkyl, and R² is C12-C20 alkyl. In embodiments, n′ is 3, m′ is 1, R¹ is C1 alkyl, and R² is C16-C20 alkyl. In embodiments, n′ is 3, m′ is 1, R¹ is C2 alkyl, and R² is C16-C20 alkyl. In embodiments, n′ is 3, m′ is 1, R¹ is C1 alkyl, and R² is C18 alkyl. In embodiments, n′ is 3, m′ is 1, R¹ is C2 alkyl, and R² is C18 alkyl. In embodiments, the organosilane is octadecyltrimethoxysilane.

In embodiments, the admixing of step a) comprises the nanoclay and the organosilane in a mass ratio in a range of about 5:1 to about 1:5, respectively. In embodiments, the nanoclay and the organosilane are in a mass ratio in a range of about 4:1 to about 1:2, or about 3:1 to about 1:2, or about 3:1 to about 1:1, or about 2.5:1 to about 1.5:1, or about 2:1, respectively. In embodiments, the nanoclay and the organosilane are in a mass ratio in a range of about 2.5:1 to about 1.5:1, respectively. In embodiments, the nanoclay and the organosilane are in a mass ratio of about 2:1, respectively.

In embodiments, the base and water have a pH in a range of about 9 to about 12. In embodiments, the base and water have a pH in a range of about 8 to about 11.

In embodiments, the admixing further comprises a tetraalkoxysilane and/or orthosilicic acid.

As used herein, the term “tetraalkoxysilane” refers to a compound having a formula of: Si(OR³)₄, wherein R³ is C1-C6 alkyl. Non-limiting examples of the tetraalkoxysilane include tetramethoxysilane, tetraethoxysilane, tetra-n-propoxysilane, tetraisopropoxysilane, tetra-n-butoxysilane, tetraisobutoxysilane, tetra-sec-butoxysilane, tetra-tert-butoxysilane, tetraphenoxysilane, monoethoxytrimethoxysilane, monobutoxytrimethoxysilane. In embodiments, R³ is C1-C4 alkyl. In embodiments, R³ is C1-C2 alkyl. In embodiments, the tetraalkoxysilane is tetramethoxysilane or tetraethoxysilane. In embodiments, the tetraalkoxysilane is tetraethoxysilane.

In embodiments, the admixing of step a) comprises the nanoclay and the tetraalkoxysilane and/or orthosilicic acid in a mass ratio in a range of about 5:1 to about 1:5, respectively. In embodiments, the nanoclay and the tetraalkoxysilane and/or orthosilicic acid are in a mass ratio in a range of about 4:1 to about 1:2, or about 3:1 to about 1:2, or about 3:1 to about 1:1, or about 2.5:1 to about 1.5:1, or about 2:1, respectively. For example, the nanoclay and the tetraalkoxysilane and/or orthosilicic acid are in a mass ratio of about 1:1, 1.5:1, 2:1, 2.5:1, 3:1 or 4:1. In embodiments, the nanoclay and the tetraalkoxysilane and/or orthosilicic acid are in a mass ratio in a range of about 2.5:1 to about 1.5:1, respectively. In embodiments, the nanoclay and the tetraalkoxysilane and/or orthosilicic acid are in a mass ratio of about 2:1, respectively.

In embodiments, the admixing of step a) can be carried out at a temperature in a range of about 30° C. to about 100° C. In embodiments, the admixing of step a) occurs at a temperature in a range of about 40° C. to about 100° C., for example, in a range of about 50° C. to about 90° C., or about 50° C. to about 80° C., or about 55° C. to about 80° C., or about 55° C. to about 75° C., or about 60° C. For example, the admixing of step a) occurs at a temperature of 35° C., 40° C., 45° C., 50° C., 55° C., 60° C., 65° C., 70° C., 75° C., 80° C., or 90° C. In embodiments, the admixing of step a) occurs at a temperature in a range of about 50° C. to about 70° C. In embodiments, the admixing of step a) occurs at a temperature in a range of about 55° C. to about 65° C. In embodiments, the admixing of step a) occurs at a temperature of about 60° C. The admixture is heated for about 1 minute to about 2 hours. In embodiments, the admixture is heated for about 30 minutes to about 1.5 hours, or about 45 minutes to about 1.25 hours, or about 1 hour. In embodiments, the admixing of step a) further comprises cooling the admixture to room temperature. In embodiments, the admixing of step a) further comprises stirring the admixture at room temperature for about 1 hour to about 72 hours, or about 12 hours to about 72 hours, or about 24 hours to about 72 hours, or about 48 hours.

In embodiments, prior to the admixing of step a), the method further comprises a step comprising admixing a base, water, and a tetraalkoxysilane to form orthosilicic acid. The admixing of the base, water, and the tetraalkoxysilane can be carried out at a temperature in a range of about -30° C. to about 30° C.

In embodiments, the admixing of step a) further comprises sonicating the admixture prior to heating the admixture. In embodiments, the sonication can occur for in a range of about 1 minute to about 2 hours, or about 1 minute to about 1 hour, or about 15 minutes to about 1 hour, or about 30 minutes. In embodiments, sonicating the admixture occurs at room temperature.

In embodiments, the admixing of step a) comprises a solvent. In embodiments, the solvent comprises a polar protic solvent. Non-limiting examples of the polar protic solvent include methanol, ethanol, isopropanol, butanol, and pentanol. In embodiments, the polar protic solvent comprises one or more of methanol, ethanol, isopropanol, and butanol. In embodiments, the polar protic solvent is ethanol.

The method as disclosed herein comprises coating polyurethane foam with the silanized nanoclay. As used herein, the term “silanized nanoclay” refers to a nanoclay as defined above that is modified with an organosilane as defined above, orthosilicic acid and/or a tetraalkoxysilane, or both an organosilane and orthosilicic acid and/or a tetraalkoxysilane.

Coating the polyurethane foam with the silanized nanoclay can include any coating method suitable to one of ordinary skill in the art. Non-limiting examples of coating methods include dip-coating. In embodiments, coating the polyurethane foam with the silanized nanoclay comprises dip-coating the polyurethane foam in a dispersion of silanized nanoclay.

In embodiments, the dispersion of silanized nanoclay comprises silanized nanoclay and a solvent. In embodiments, the solvent comprises a polar protic solvent. Non-limiting examples of the polar protic solvent include methanol, ethanol, isopropanol, butanol, and pentanol. In embodiments, the polar protic solvent comprises one or more of methanol, ethanol, isopropanol, and butanol. In embodiments, the polar protic solvent is ethanol. In embodiments, the silanized nanoclay dispersion has a concentration of silanized nanoclay in a range of about 0.01 wt% to about 20 wt%, or about 0.1 wt% to about 10 wt%, or about 0.5 wt% to about 10 wt%, or about 1 wt% to about 5 wt%, based on the total weight of the silanized nanoclay dispersion. In embodiments, the silanized nanoclay dispersion has a concentration of silanized nanoclay in a range of about 1 wt% to about 5 wt%, based on the total weight of the silanized nanoclay dispersion. In embodiments, the silanized nanoclay dispersion has a concentration of silanized nanoclay of about 1 wt%, 2 wt%, 3 wt%, 4 wt%, or 5 wt%, based on the total weight of the silanized nanoclay dispersion. In embodiments, the silanized nanoclay dispersion has a concentration of silanized nanoclay of about 1 wt%, based on the total weight of the silanized nanoclay dispersion. In embodiments, the silanized nanoclay dispersion has a concentration of silanized nanoclay of about 3 wt%, based on the total weight of the silanized nanoclay dispersion. In embodiments, the silanized nanoclay dispersion has a concentration of silanized nanoclay of about 5 wt%, based on the total weight of the silanized nanoclay dispersion.

In embodiments, the admixing of step b) comprises the silanized nanoclay and the polyurethane foam in a molar ratio in a range of about 1:1 to about 10:1, respectively. In embodiments, the silanized nanoclay and the polyurethane foam are in a molar ratio in a range of about 1:1 to about 8:1, or about 1:1 to about 5:1, or about 1:1 to about 4:1, or about 1:1 to about 3:1, or about 1:1 to about 2:1, respectively. For example, the silanized nanoclay and the polyurethane foam are in a molar ratio in a range of about 1:1, 1.5:1, 2:1, 2.5:1, 3:1, 4:1 or 5:1. In embodiments, the silanized nanoclay and the polyurethane foam in a molar ratio in a range of about 1:1 to about 2:1, respectively. In embodiments, the silanized nanoclay and the polyurethane foam in a molar ratio in a range of about 1:1 to about 1.5:1, respectively.

Coating the polyurethane foam can occur for in a range of about 1 hour to about 48 hours. In embodiments, coating the polyurethane foam occurs for in a range of about 6 hours to about 40 hours, or about 12 hours to about 36 hours, or about 16 hours to about 30 hours, or about 20 hours to about 30 hours, or about 24 hours. In embodiments, coating the polyurethane foam occurs for about 24 hours.

Coating the polyurethane foam can occur at any temperature suitable to the ordinary skilled artisan. In embodiments, the coating occurs at ambient temperature.

The method as disclosed herein can further comprise a step c): drying the coated article. In embodiments, drying the coated article can occur at a temperature in a range of about 50° C. to about 150° C. In embodiments, drying the coated article occurs at a temperature in a range of about 80° C. to about 120° C., such as about 100° C. In embodiments, drying the coated article occurs for in a range of about 10 minutes to about 6 hours, or about 1 hour to about 6 hours, or at least about 2 hours.

### Water Treatment

Also provided herein are methods of treating water comprising admixing the coated article as disclosed herein and an oil-water mixture. The admixing can occur at any temperature suitable to one of ordinary skill in the art. In embodiments, the admixing occurs at ambient temperature. In embodiments, the admixing occurs for in a range of about 1 minute to about 2 hours, or about 5 minutes to about 1 hour, or about 5 minutes to about 30 minutes. In embodiments, the oil of the oil-water mixture comprises one or more of hexane, decane, dodecane, diesel oil, carbon tetrachloride, vegetable oil, and ethanol. In embodiments, the oil comprises one or more of hexane, decane, dodecane, carbon tetrachloride, and ethanol. In embodiments, the oil comprises one or more of diesel oil and vegetable oil. In embodiments, the oil-water mixture is oilfield wastewater. In embodiments, the oil-water mixture is produced water. As used herein, the term “produced water” refers to a mixture of oil and water that is a byproduct of the extraction of oil and/or natural gas.

In embodiments, the method further comprises recovering oil from the admixture of the coated article and the oil-water mixture. In embodiments, recovering the oil comprises separating the coated article from the oil-water mixture and applying pressure to the coated article such that the oil absorbed by the coated article is expelled from the coated article.

### EXAMPLES

### Example 1: Synthesis of a Coated Article

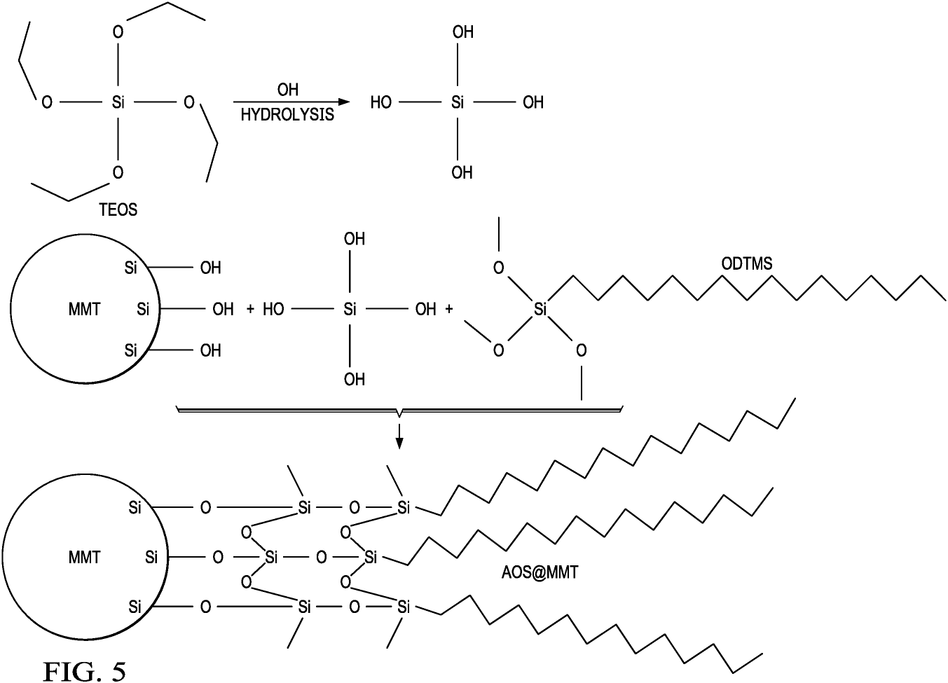

About 5 g of montmorillonite (MMT), 2.5 g of tetraethoxysilane (TEOS), and 2.5 g of Octadecyltrimethoxysilane (ODTMS) were dispersed in a mixture of 20 mL of absolute ethanol and 100 mL of aqueous ammonia to form a dispersion. The dispersion was sonicated for about 30 mins at ambient temperature. The dispersion was then heated at 60° C. for 1 h and stirred at ambient temperature for 48 h to form an alkoxysilane-modified montmorillonite clay mineral (AOS@MMT) dispersion. The AOS@MMT dispersion was transferred into a glass Petri dish, heated to 60° C. for 2 h, and allowed to sit for 12 h at ambient temperature to form an AOS@MMT powder (FIG. 5).

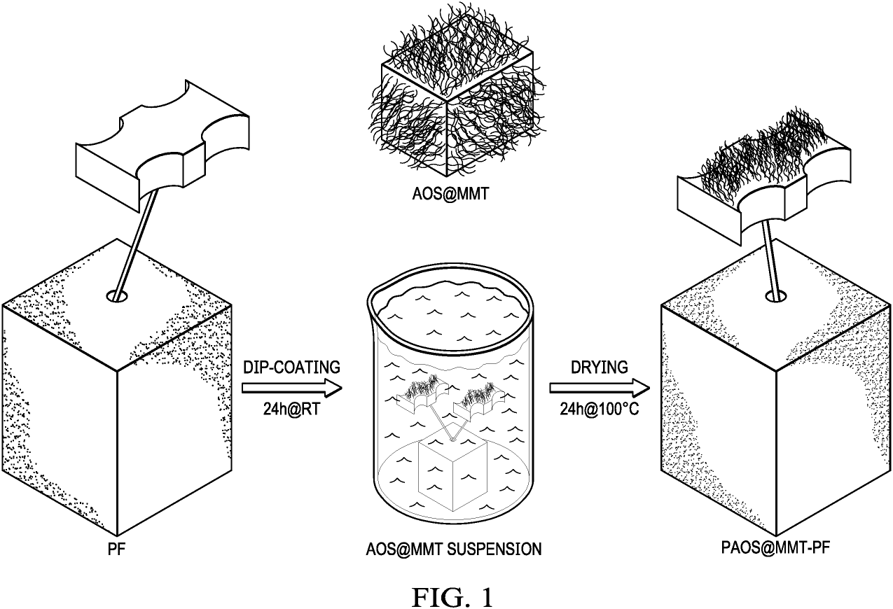

A sample of polyurethane foam (PF) was purified by repeated washing the PF with absolute ethanol under sonication in order to remove any trace impurities. The purified PF was placed in a vacuum oven for at least 2 h at 100° C. to form a dried, purified PF. The AOS@MMT powder was dispersed in the desired volume of absolute ethanol, such as AOS@MMT powder concentrations of 1 wt%, 3 wt%, and 5 wt%, based on the total weight of the dispersion. The dispersion was sonicated for 30 minutes and magnetically stirred for at least 2 h. The dried, purified PF was dipped in the dispersion, and magnetically stirred for 24 h during which the PF was turned over at intervals to achieve uniformity in the coating of AOS@MMT on the PF, to form AOS@MMT-PF. Lastly, the AOS@MMT-PF was dried in a vacuum oven for at least 2 h at 100° C. to obtain the coated article. The coated article fabrication process, e.g., AOS@MMT-PF, is shown in FIG. 1.

### Example 2: Separation Efficiency of AOS@MMT-PF

AOS@MMT-PF was dipped into an oil-water sample for amount of time to form a saturated AOS@MMT-PF. The saturated AOS@MMT-PF was weighed and repeatedly squeezed to expel oil originally from the oil-water sample. This process was repeated for at least three trials and the mean value of absorbed oil was calculated. The AOS@MMT-PF was dipped in various oil-water samples including oils and non-polar organic solvents, such as hexane, decane, dodecane, diesel oil, carbon tetrachloride, vegetable oil, ethanol and an oil mixture as disclosed above.

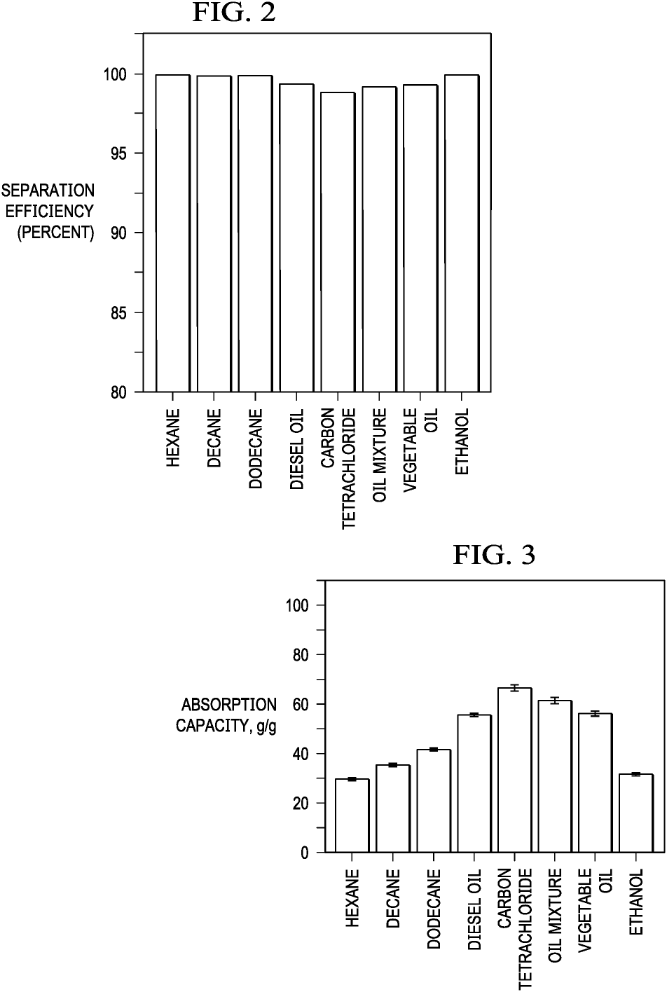

Diesel oil was absorbed swiftly by the coated foam within a very short period after dipping it on the surface of the oily wastewater. AOS@MMT-PF demonstrated superoleophilic properties and readily retrieved oil droplets above and/or below the water surface when the AOS@MMT-PF was forced down the water surface by means of a pair of tweezers. Without intending to be bound by theory, in the course of absorption, the diesel oil percolated the open pores of the 3D network of the AOS@MMT-PF by capillary force, while the water was wholly rejected by the superhydrophobic surface of the AOS@MMT-PF. The oil occupied the pore volume generated by the interconnected skeleton of the AOS@MMT-PF, which showed that the AOS@MMT-PF had a high capacity for oil absorption. The AOS@MMT-PF exhibits excellent flexibility, and the absorbed oil is readily recovered by mild mechanical squeezing of the AOS@MMT-PF. FIG. 2 shows the separation efficiency obtained when dipping a sample of AOS@MMT-PF (wherein the AOS@MMT-PF was synthesized using 5 wt% AOS@MMT dispersion based on the total weight of the dispersion) in various oil-water samples. Advantageously, the separation efficiency of AOS@MMT-PF for all the tested sample oils and organic solvents was in the range of 98.80% for carbon tetrachloride to 99.87% for hexane.

### Example 3: Absorption Capacity of AOS@MMT-PF

The absorption capacity of AOS@MMT-PF (wherein the AOS@MMT-PF was synthesized using 5 wt% AOS@MMT dispersion based on the total weight of the dispersion) was evaluated using eight various kinds of oils and organic solvents. As shown in FIG. 3, the absorption capacity of AOS@MMT-PF for the selected absorbates ranged from 29.5 gg⁻¹ for hexane to 66.5 gg⁻¹ for carbon tetrachloride. The maximum adsorption capacity depends on the viscosity and density of these organic liquids. For instance, the density of hexane is comparatively low, therefore the mass absorbed by the AOS@MMT-PF is less. On the other hand, carbon tetrachloride has a relatively high density, thus the AOS@MMT-PF absorbs a greater mass of carbon tetrachloride.

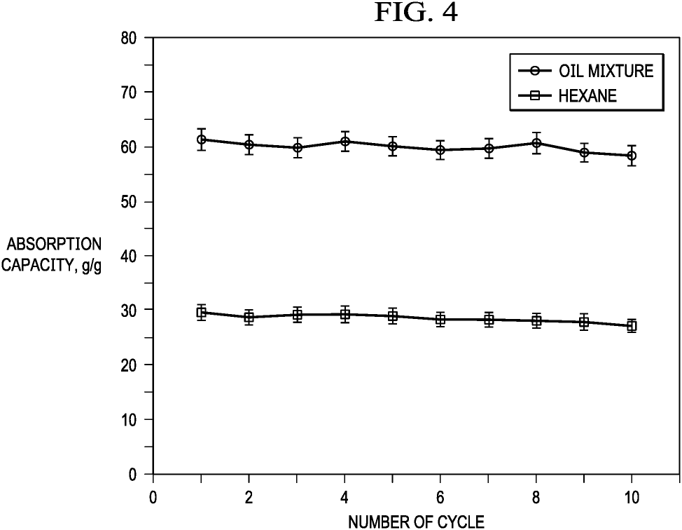

Absorbent reusability is another key factor for oil-spill cleanup. To evaluate the absorbent reusability of the AOS@MMT-PF, absorption-desorption tests were carried out for 10 adsorption-desorption cycles of a hexane-water mixture and the oil mixture-water mixture. FIG. 4 shows the absorption capacity of the AOS@MMT-PF after each of the 10 absorption-desorption cycles. As shown in FIG. 4, the absorbent reusability experiment revealed that AOS@MMT-PF, advantageously, had an absorption capacity of over 90% and sustained this absorption capacity for at least 10 cycles of absorption-desorption cycles.

While certain embodiments have been described, the disclosure is not limited to such embodiments.

As an example, polyurethane foam has been described. In many cases, porous polyurethane is desirable because of its ease of microcellular foaming, and control over formation of pores. Nonetheless, the disclosure is not limited to polyurethane foams. In some embodiments, a different polymer foam can be used. Examples of polymers include polystyrene polyethylenes, polyisocyanurates, polyacrylonitriles, polyetherimides, polysulfones, polydimethylsiloxans, polyvinylidene fluorides, rubbers polydopamines, poly(2-vinylpyridine)s, polyhexadecyl acrylates, polytetrafluoroethylenes, and polyphenolics. Foams of such polymers are encompassed by the disclosure.

As another example, while embodiments have been disclosed with TEOS and ODTMS, other silanes may be used. Examples such silanes include triethoxy(ethyl)silane, triethoxymethylsilane, trimethoxymethylsilane, dimethoxydimethylsilane, trimethoxymethylsilane and (3-Aminopropyl)triethoxysilane.

As a further example, while embodiments have been described that use NH₃ as a base, the disclosure is not limited in this sense. In some embodiments, a different base can be used. Examples include NaOH and KOH.

In general, the amount of alcohol can be selected as appropriate. In some embodiments, the amount of alcohol (e.g., ethanol) was from about 10 weight percent to about 50 weight percent.

Generally, the ratio of MMT:TEOS:ODTMS (or their equivalents) can be selected as appropriate. In some embodiments, the ratio of MMT:TEOS:ODTMS (or their equivalents) was 4:1:1.

As a general matter, the temperature for hydrolytic condensation can be selected as desired. In some embodiments, the temperature was from 50° C. to 100° C.

Generally, the stirring time of AOS@MMT and PF can be selected as desired. In some embodiments, this stirring time was from 10 minutes to two hours.

Other embodiments are encompassed by the claims.

What is claimed is:

1. A coated article comprising:
a polyurethane foam; and
a coating comprising silanized nanoclay,
wherein the coating is supported by the polyurethane foam, the silanized nanoclay comprises a phyllosilicate mineral and an organosilicate, and the organosilicate comprises one or more C8-C30 alkyl chains.

2. The coated article of claim 1, wherein the silanized nanoclay further comprises orthosilicate.

3. The coated article of claim 1, wherein the organosilicate comprises one or more C10-C24 alkyl chains.

4. The coated article of claim 3, wherein the organosilicate comprises one C18 alkyl chains.

5. The coated article of claim 1, wherein phyllosilicate mineral comprises one or more of halloysite, kaolinite, pyrophyllite, talc, illite, montmorillonite, chlorite, vermiculite, sepiolite, and palygorskite.

6. The coated article of claim 1, wherein the phyllosilicate mineral comprises montmorillonite.

7. The coated article of claim 1, wherein the silanized nanoclay has an average particle size distribution in a range of about 60 nm to about 90 nm.

8. The coated article of claim 1, wherein the silanized nanoclay has an average particle size distribution in a range of about 65 nm to about 85 nm.

9. The coated article of claim 1, wherein the coated article has a separation efficiency of at least 90 wt% in an oil-water mixture, wherein the coated article is provided in an amount of about 5 wt% based on the total weight of oil-water mixture.

10. The coated article of claim 1, wherein the coated article has a separation efficiency of at least 95 wt% in an oil-water mixture, wherein the coated article is provided in an amount of about 5 wt% based on the total weight of oil-water mixture.

11. The coated article of claim 10, wherein the oil in the oil-water mixture comprises one or more of hexane, decane, dodecane, diesil oil, carbon tetrachloride, vegetable oil, and ethanol.

12. The coated article of claim 1, wherein the coated article sustains an absorption capacity of about ±10% of the first absorption capacity in an oil-water mixture for at least 5 absorption-desorption cycles.

13. A method, comprising:
mixing a nanoclay, an organosilane, water, and a base to form a silanized nanoclay; and
coating a polyurethane foam with the silanized nanoclay to form the coated article, thereby making the coated article of claim 1.

14. The method of claim 13, wherein the organosilane is octadecyltrimethoxysilane.

15. The method of claim 13, wherein mixing further comprises a tetraalkoxysilane and/or orthosilicic acid.

16. The method of claim 13, wherein the base and water have a pH in a range of about 8 to about 11.

17. The method of claim 13, wherein the admixing comprises heating the admixture at a temperature in a range of about 55° C. to about 65° C.

18. A method of treating water comprising mixing the coated article of claim 1 and an oil-water mixture.

19. The method of claim 18, wherein the oil-water mixture comprises produced water.

20. The method of claim 18, further comprising at least partially separating the oil from the water by adsorbing at least some of the oil onto the coated particle.
